(19) United States
(12) Patent Application Publication
(10) Pub. No.: US 2023/0327454 A1
(43) Pub. Date: Oct. 12, 2023

(54) INDUSTRIAL PLANT AND SYSTEM AND METHOD TO POWER AN INDUSTRIAL PLANT

(71) Applicant: DANIELI AUTOMATION S.P.A., Buttrio (IT)

(72) Inventor: Antonello Mordeglia, Bangkok (TW)

(73) Assignee: DANIELI AUTOMATION S.P.A., Buttrio (IT)

(21) Appl. No.: 18/022,151

(22) PCT Filed: Aug. 10, 2021
(86) PCT No.: PCT/IT2021/050260

§ 371 Date: Feb. 18, 2023

(30) Foreign Application Priority Data
Aug. 20, 2020 (IT) 102020000020281

(51) Int. Cl. H02J 3/38

(52) U.S. Cl. CPC H02J 3/381; H02J 2300/24

(57) ABSTRACT

An industrial plant for treating materials includes one or more lines for treating materials and one or more user devices and a system for supplying electrical energy. The power supply system includes a power supply circuit disposed in a site of the plant connected to the latter, and configured to supply electrical energy to said one or more user devices. A method to supply electrical energy to the plant is also disclosed.

### FIELD OF THE INVENTION

The embodiments described here concern an industrial plant, in particular for treating metal material, and a system and method to supply electrical energy for said industrial plant. An example of an industrial plant of this type can be a steel plant comprising at least one of either a line for melting the metal material or a rolling line.

The system and method according to the invention provide to power the industrial plant with electrical energy supplied by renewable energy sources, allowing to reduce the environmental impact and emissions due to the production of traditional electrical energy.

### BACKGROUND OF THE INVENTION

Large-scale industrial plants, such as steel plants for example, generally use electrical energy taken from the public network. The steel industry is extremely energy-intensive, as it requires the metal material to be melted and processed at high temperatures.

The electrical energy produced by the public network is mostly obtained from the combustion of fossil fuels, in particular coal, oil and gas, with the consequent emissions, in particular carbon dioxide, into the atmosphere.

To limit and reduce these emissions, various national authorities have encouraged the use of renewable sources as an alternative to fossil fuels and have penalized the use of the latter through emission taxation systems. In particular, the emissions that a producer creates through its production processes are taxed directly and the emissions deriving from the production of public electrical energy are taxed indirectly.

The taxes on emissions resulting from the production of electrical energy are calculated pro-quota in proportion to the consumption of the electrical energy by users.

The need is therefore increasingly felt to provide “clean” electrical energy with a low environmental impact.

The need is also felt to avoid the costs resulting from the application of the so-called “carbon tax” on the operating margins of business activities due to emissions.

Several companies have initiated processes to gradually support and replace energy sources, preferring self-production of clean energy thanks to renewable sources rather than using the public network.

The availability of land and surfaces suitable for the installation of renewable energy sources on the site of the production plant or in the zones immediately adjacent to it may not be sufficient to provide the electrical energy necessary for energy-intensive plants such as steel plants, and therefore it is necessary in any case to integrate the portion of electrical energy required by using the public network.

To make the production site completely autonomous and independent from the public network, it may be necessary for an operator in the sector to invest in the generation of electrical energy from renewable sources in areas distant from the production site, for example within a radius of a few dozen kilometers.

The production of electrical energy in areas distant from the production site entails problems related to storage, transporting the energy and related costs.

Electrical energy is normally transported by cable, but there may not be an electricity network available near the plant, and the creation of a new cable line would have enormous costs, as well as problems with permits to cross different lands and properties.

Another disadvantage caused by the transport of energy via cable is that of the energy losses which occur following the transformation of the alternating current AC in the event that the renewable source produces energy in direct current DC (such as for example in the case of photovoltaic panels), or the energy losses that occur along the transmission cables.

Document US 2011/0282807 A1 describes a system and a method to transfer energy from one site to another to supply it to a user device.

Document DE202019106279U1 refers in general to electrical energy systems, and more particularly to mobile and fixed systems to generate, acquire and store commercial and industrial energy, that is, electrical storage systems of the type generally referred to as ESS (Electrical Storage Systems).

There is therefore a need to perfect a system and a method to power an industrial plant, which can overcome at least one of the disadvantages of the state of the art.

One purpose is to provide a power supply system for an industrial plant that allows to power it substantially completely with energy generated by renewable sources so as to contribute to the reduction of emissions into the atmosphere and reduce the taxation charges associated with them.

One purpose of the present invention is to provide a system and a method to power an industrial plant that reduce energy losses to a minimum.

Another purpose is to provide a power supply system and method that are efficient and guarantee the supply of the necessary electrical energy at all times of the production process.

Another purpose of the invention is to provide a system and a method to power an industrial plant that allow to optimize the management of the electrical energy available.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, the present invention concerns an industrial plant for treating materials which is provided with a power supply system for supplying electrical energy, wherein the plant comprises one or more lines for treating materials and one or more user devices.

The industrial plant can be a steel plant comprising at least one of either a line for melting metal material provided with at least one furnace, or at least one rolling line provided with one or more user devices such as rolling stands, heating furnaces and other known devices.

According to some embodiments, the power supply system comprises at least one power supply circuit connected to the plant and disposed in correspondence with the plant site, suitable to supply energy to the one or more user devices.

According to one aspect of the present invention, the power supply system comprises one or more stations for producing electrical energy from renewable sources disposed in different production areas, which are disposed distanced from the site of the industrial plant, for example within a radius comprised between 5 and 60 km.

According to some embodiments, the stations for generating energy are provided with generating apparatuses configured to receive and transform into electrical energy the energy supplied by the renewable sources, such as for example solar, wind, hydroelectric, geothermal, tidal or wave energy.

The power supply system also comprises electrical energy storage devices, suitable to be transported, and a plurality of transport means configured to transport the storage devices from the production area to the site of the industrial plant.

Additionally, the power system can comprise a central management unit configured to manage and regulate the supply of electrical energy to the plant.

In particular, the central management unit is configured to manage the movement of the plurality of transport means and of the storage devices associated therewith as a function of one or more of either the energy demands of the plant, the availability of electrical energy supplied by the renewable sources in the production stations, the distance between the production stations and the plant site, the recharging speed and storage capacity of the storage devices.

The management unit is also configured to command the delivery of the energy supplied by the storage devices in the power supply circuit as a function of the different process steps of the at least one treatment line.

According to some embodiments, the transport means comprise transport means on tires, such as trucks, vans or articulated lorries.

The storage device, as a function of the size and quantity of electrical energy it has to store, can be suitable to be loaded onto a truck, or connected to it as a trailer.

If, on the other hand, the storage device is an integral part of the truck, that is, battery-trucks are used, it is not necessary to load/unload the storage device from the truck, but it is sufficient to connect the truck itself to the network connection unit of the plant.

The power supply circuit as above can comprise at least one common direct line or bus for direct current connection, to which the various user devices can be connected and from which they can draw energy.

According to preferred embodiments, all the user devices of at least one treatment line are connected to a same common bus.

The power supply circuit can also comprise at least one connection unit by means of which the common bus can be connected to one or more electrical energy storage devices, and receive from the latter the electrical energy necessary to supply electrical energy to the one or more lines for treating the materials and/or the one or more user devices.

The power supply circuit can also comprise at least one power supply apparatus, connected between the connection unit and at least one user device, suitable to power the user device with alternating current with desired amplitude and frequency.

The connection unit can advantageously comprise two or more bays, each provided with fast connection devices, suitable to be connected to a respective storage device, or possibly to the truck itself.

According to some embodiments, two or more storage devices are connected in parallel to each other to the power supply circuit of the plant, directly in correspondence with the direct current DC connection unit.

In the event that one or more user devices have to be powered with energy in alternating current AC, the conversion of the electrical energy can be carried out by means of the power supply apparatus, or dedicated devices for conversion into alternating energy AC can be provided, which are associated with each of the user devices.

This solution is particularly advantageous to be able to store electrical energy from renewable sources in direct current DC, reducing possible energy losses to a minimum. In the event that the renewable sources are of the alternating current type, such as for example wind turbines, hydroelectric turbines and suchlike, converter devices are provided in correspondence with the production stations in order to transform the electrical energy from alternating current AC to direct current DC.

The storage devices, loaded on or integrated into the trucks themselves, can be transferred from the production station to the plant site and be connected to the power supply circuit by means of the connection unit, in order to supply “clean” electrical energy to the plant lines and to the user devices. Once the amount of electrical energy has ran out, the storage device is once again transferred to a production station in order to be recharged.

According to possible embodiments, the truck can be of the electric traction type and be powered with the same electrical energy stored in the storage device.

According to some embodiments, the transport means are provided with a control unit of their own configured to monitor the state of charge of the storage device associated therewith and communicate it to the central management unit or possibly also to the control units provided on the other transport means.

The communication between the different control units and the central management unit can occur via radio, or by means of other wireless communication means, for example via the internet.

According to some embodiments, the central management unit takes into account the energy withdrawals of the plant as a function the programmed production and of the generation rates of the renewable energy sources disposed in the various production stations and of the number of trucks present in the industrial plant, in the production stations, or in transit between the various sites. The tracking of the trucks can be done by means of GPS (Global Positioning System).

Thanks to the system and method to supply energy according to the invention it is possible to power an industrial plant in a clean and eco-sustainable way, even a particularly energy-intensive one, such as a steel plant can be.

By providing a plurality of energy production stations located in various areas and a plurality of storage devices in the form of high-capacity rechargeable batteries, having limited weight and sizes, it is possible on each occasion to load onto a single transport mean an amount of electrical energy equal to approximately 25-30 MW and even more, for example up to 50 MW.

In the case of a storage capacity of approximately 50 MW, a single truck/storage device can cover the needs of an entire steel plant for about one hour of production, considering that melting (EAF—Electric Arc Furnace) and refining (LF—Ladle Furnace) electric furnaces consume an average of 30 MWh, and a casting machine (CCM—Continuous Casting Machine) and a rolling mill (RM) together consume an average of 20 MWh.

In relation to the type of renewable energy source used in a production station, storage devices of the static type can also be provided, configured to store the energy produced when it is more convenient, or there is an over-production thereof, and use it later, when necessary, to recharge the mobile storage devices. This can be particularly useful in the case of renewable sources in which discontinuities in the flow of energy generation occur, and there are strong intermittences that can complicate the work of balancing consumption and generation such as for example in the case of wind farms if there are strong gusts of wind, or in the case of tidal energy or wave motion with excessively high waves.

Some embodiments described here also concern a method to power an industrial plant, which provides to produce electrical energy from renewable sources in one or more production stations disposed far away from the site where the plant is positioned, and provided with respective apparatuses for generating energy, to store the electrical energy produced on mobile and transportable storage devices, to transfer the storage devices by means of transport means on wheels from the production stations to the production plant and to connect them to a power supply circuit of the plant in order to power one or more user devices.

The method can provide to manage and monitor the movements of the transport means and the charge/use of the storage devices as a function of the energy demand of the plant and the availability of electrical energy in the production stations.

According to some embodiments, it can be provided to charge a storage device in a production station until the maximum charge capacity is reached, and subsequently transfer the storage device with a respective transport mean to the plant and connect it to a power supply circuit thereof by means of a connection unit in direct current DC, and power the power supply circuit of the plant with the energy supplied by the storage device until the amount of charge present therein falls below a determinate threshold level.

Preferably, in correspondence with the connection unit, two or more storage devices can be connected in parallel to each other, in such a way as to guarantee a continuous power supply to the plant and allow a correct replacement of the discharged storage devices without causing interruptions in the electric power supply.

According to some embodiments, the number of storage devices connected in parallel can be chosen on the basis of one or more of the following parameters:
number of production stations provided;
type of renewable energy sources;
recharging speed of the storage devices;
number of storage devices that can be recharged in each production station;
distance between the production stations and the plant site.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a diagram of a power supply system for supplying electrical energy of a plant for treating materials according to the invention;

FIG. 2 is a detailed diagram of the power supply system of FIG. 1.

To facilitate comprehension, the same reference numbers have been used, where possible, to identify identical common elements in the drawings. It is understood that elements and characteristics of one embodiment can conveniently be combined or incorporated into other embodiments without further clarifications.

### DETAILED DESCRIPTION OF SOME EMBODIMENTS

We will now refer in detail to the possible embodiments of the invention, of which one or more examples are shown in the attached drawings, by way of a non-limiting illustration. The phraseology and terminology used here are also for the purposes of providing non-limiting examples.

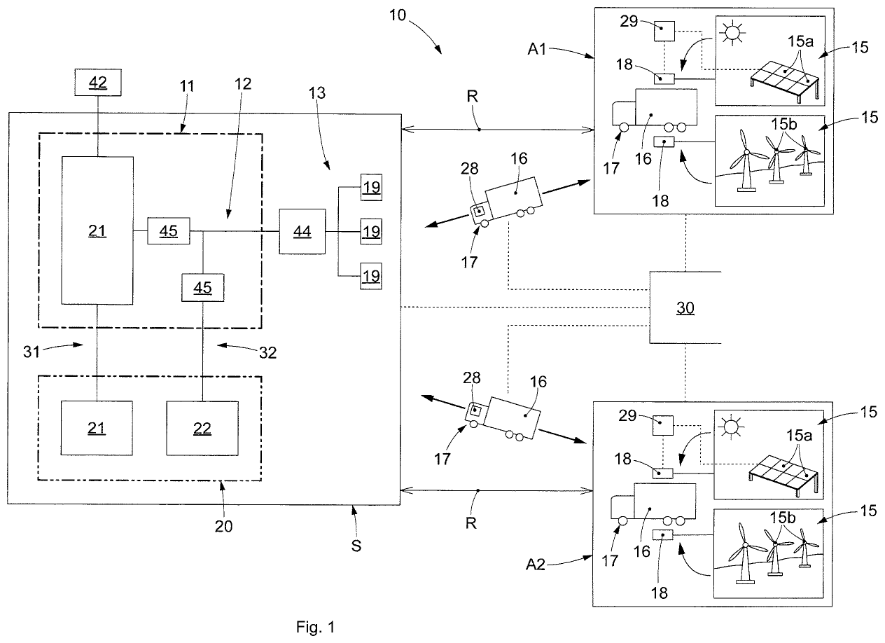

FIG. 1 schematically shows a power supply system 10 according to the invention for supplying electrical energy to an industrial plant 20 for treating materials.

The invention also concerns an industrial plant 20 for treating materials, in particular a steel plant comprising at least one of either a line 22 for melting metal material or at least one rolling line 23.

The plant 20 can comprise one or more lines 22, 23 for treating materials and one or more user devices 24, 25, 26, 27.

The power supply system 10 comprises a power supply circuit 11 to power the plant, disposed in the site S of the plant 20 and configured to supply electrical energy to the treatment lines 22, 23 and to the user devices 24, 25, 26, 27.

The power supply circuit 11 can comprise at least one common line or bus 12 for direct current connection, to which the various user devices 24, 25, 26, 27 can be connected and from which they can draw energy.

The power supply circuit 11 can comprise at least one connection unit 13 by means of which the common bus 12 can be connected to one or more electrical energy storage devices 16 and receive from these the electrical energy necessary to supply electrical energy to the one or more lines 22, 23 for treating materials and/or to the one or more user devices 24, 25, 26, 27.

The power supply system 10 can comprise one or more stations 14 for producing energy from renewable sources disposed in different production areas A1, A2.

The production areas A1, A2 are preferably disposed away from the site S of the plant 20, for example within a radius R comprised between 5 and 60 km, and preferably within a radius R comprised between 10 and 50 km.

By way of example, the renewable energy sources can be chosen from solar energy, wind energy, hydroelectric energy, biomass energy, tidal energy, wave energy, or other.

Depending on the type of energy source considered, in the production stations 14 there are provided respective plants and apparatuses for generating energy 15 configured to receive and convert the energy supplied by the renewable source into electrical energy.

By way of example, FIG. 1 shows two types of energy generating apparatuses 15, comprising respectively a plurality of photovoltaic panels 15a and a plurality of wind turbines 15b. In the case of plants that exploit hydroelectric energy or sea waves, electric turbines will be provided, and so on.

As a function of the geographical position and size of the production areas A1, A2, it can be provided that there is a single type of energy generating apparatus 15, or two or more different types.

The power supply system 10 can also comprise a plurality of mobile storage devices 16, that is, suitable to be transported between the production stations A1, A2 and the plant 20, and vice versa.

For this purpose, the power supply system 10 comprises a plurality of transport means 17 configured to transport the storage devices 16 from the production area A1, A2 to the site S of the plant 20.

The storage devices 16 can be made with high-capacity rechargeable batteries, and can have sizes and capacities suitable to allow to store an amount of energy equal to or greater than about 25-30 MWh, preferably up to about 50 MWh as a function of the total weight that can be transported by the transport means 17.

According to some embodiments, the transport means are preferably transport means on wheels, such as trucks 17 or articulated trucks.

The storage devices 16 can be integrated in the truck 17 or integrated on a trailer which can be connected to a towing vehicle, whereby the transport means 17 themselves define a mobile storage device 16, for example a battery-truck.

According to possible embodiments, the trucks 17 can be of the electric traction type and be powered with the same electrical energy stored in the storage device 16 loaded on, or integrated in, the truck 17 itself. This would allow to further reduce polluting emissions.

According to some embodiments, first connection devices 18 are provided in correspondence with the production stations 14, connected on one side to the energy generating devices 15 and able to be connected on the other side to the storage devices 16, in order to recharge them with the energy generated by the renewable sources.

In correspondence with the site S of the plant 11, the connection unit 13 can be provided with one or more second connection devices 19, each suitable to connect to a respective storage device 16, or to a truck 17 associated with the storage device.

At least two second connection devices 19 can also be provided, configured to simultaneously connect at least two storage devices 16 in parallel to each other. In this way, it is possible on each occasion to replace one of the storage devices 16, keeping the other connected so as to guarantee a continuous power supply of the plant 11.

The first 18 and/or the second connection devices 19 can be of the quick connection automatic type, and preferably of the type that does not require the intervention of an operator, in order to guarantee safety.

The power supply system 10 can comprise a central management unit 30 configured to manage and regulate the movement of the plurality of transport means 17 and of the storage devices 16 associated therewith as a function of one or more of either the energy demands of the production plant 20, the availability of electrical energy in the production stations 14, the distance between the production stations 14 and the plant 20, or the recharging speed and the storage capacity of the storage devices 16.

According to some embodiments, the management unit 30 can also command the movement of the transport means 17 and of the storage devices 16 as a function of the planned production needs of the plant 20.

The management unit 30 can also be configured to regulate the delivery of the energy received from the storage devices 16 along the power supply circuit 11 as a function of the different steps of the treatment process along one or each line 22, 23.

In particular, the management unit 30 can regulate the supply of energy to the various user devices 24, 25, 26, 27 as a function of one or more of either the type of metal material to be melted, or the shape and/or size of the product to be rolled. The management unit 30, in particular, can regulate the supply of electrical energy to the furnace 24 as a function of the steps of the process of drilling the metal material, melting the metal and refining, for example in order to supply greater electric current in the drilling step and decrease it in the refining step.

According to some embodiments, each of the transport means 17 can be provided with a control unit 28 of its own, configured at least to monitor the state of charge of the storage device 16 associated therewith, and communicate it to the central management unit 30.

The communication between the different control units 28 and the central management unit 30 can occur via radio, or by means of other wireless communication means, for example via the internet.

It can also be provided that the control units 28 provided on respective transport means 17 can also communicate with each other to exchange data and information at least in relation to the amount of charge available, or even possibly their position.

The central management unit 30 can take into account the energy withdrawals of the industrial plant 20 as a function of the programmed production and the generation rates of the renewable energy sources disposed in the various production stations 14 and the number of transport means 17 present in the industrial plant 20, in the production stations 14, or in transit between the various sites S, A1, A2.

The tracking of the transport means 17 can be carried out by means of GPS (Global Positioning System) technology, by providing suitable tracking devices on each of the transport means 17.

Monitoring units 29 can be provided in correspondence with the different production stations 14, configured to monitor one or more of either the trend of the energy supplied by the renewable sources, the energy generation capacity of the generating apparatuses 15, or the recharging speed of the first connection devices 18, and to communicate the detected data to the management unit 30.

In this way, at any time the management unit 30 is able to know where the transport means 17 are located, how much charge is present in the respective storage devices 16, and how much energy is available at the production stations 14, and can therefore optimize the movements of the transport means 17 between them.

For example, in the event that there are production stations 14 with different types of renewable sources, the management unit 30 can organize the transfer of the transport means so as to send them during the day to one production station 14, for example in which there is a photovoltaic system, while at night, or in case of bad weather, the transport means 17 can be diverted to another production station 14, for example provided with a wind power plant or plants for recovering tidal or wave energy.

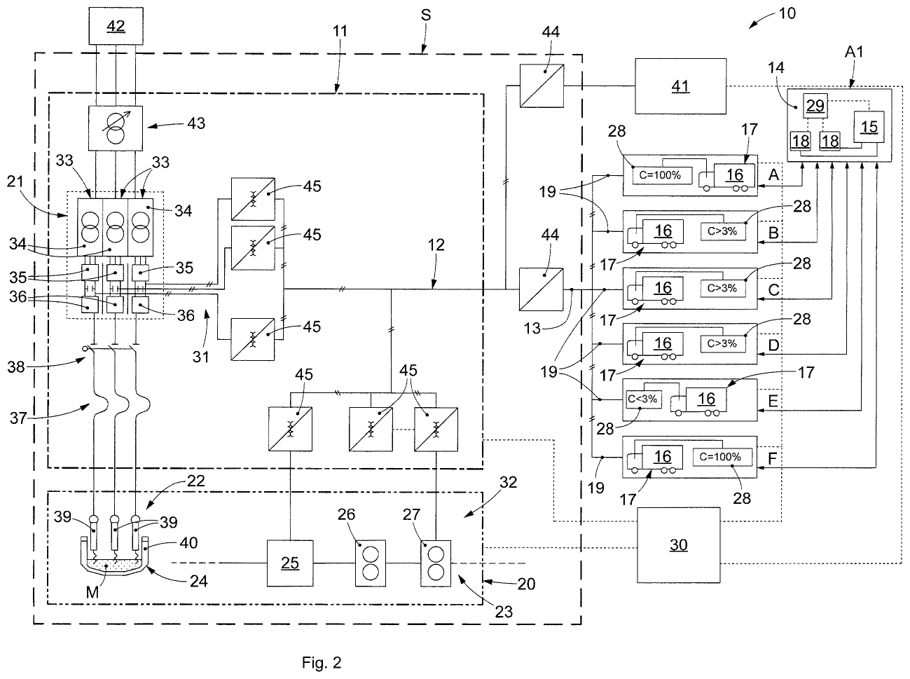

According to other embodiments, for example described with reference to FIG. 2, the power supply system 10 can comprise at least one alternative energy source 41 connected to the power supply circuit 11 and able to supply power supply energy to the one or more lines 22, 23 for treating materials and/or to the one or more user devices 24, 25, 26, 27 in addition, or as an alternative, to the electrical energy supplied by the storage devices 16.

The alternative energy source 41 can comprise one or more renewable energy sources and/or one or more non-renewable energy sources able to supply electrical energy in direct current or in alternating current.

With regard to renewable energy sources, various technologies can be provided in this context, linked both to climatic/environmental parameters (sun, wind, hydrogeological morphology, etc.) and also to the availability of other forms of energy obtainable through transformation (e.g. biomass, hydrogen, vegetable oil, etc.). The non-renewable energy source, for example, can derive from the combustion of fossil fuels, such as oil, coal, or gas.

According to some embodiments, the alternative energy source 41 is preferably connected to the common bus 12, possibly by means of a converter 44.

Also providing an alternative energy source 41 directly connected to the power supply circuit 11 helps to make the power supply system 10 more versatile in selecting the most suitable electrical energy to power the plant 20 at any time.

According to other embodiments, it can also be provided that in the site S of the plant 20 there is a connection to an electricity network 42.

In this case, the management unit 30 can manage the supply of electrical energy to the plant 20 and the transfer of the transport means 17 to and from the production stations 14 also as a function of the electrical energy supplied to the plant by the alternative energy source 41 and possibly by the electricity network 42. For example, the management unit 30 can also be configured to monitor one or more parameters from the functioning status, the quality, quantity and/or cost of electrical energy available from the electricity network 42 and from the at least one alternative energy source 41, and the quantity of energy required by the plant 20 in order to supply electrical energy to the latter also as a function of the respective functioning status and overall energy costs.

In the case of a connection to an electricity network 42, it can be provided that the power supply system 10 is of the hybrid type, and that it can power the plant 20 partly with the electrical energy supplied by the storage devices 16 and partly with the electrical energy supplied by the electricity network 42.

It can also be provided that the power supply system 10 can introduce into the network the possible residual electrical energy of the storage devices 16, for example due to a scheduled or sudden stoppage of the plant 20, possibly allowing to receive a corresponding fee from the network operator.

Furthermore, with reference to FIG. 2, the plant 20 could be, by way a of non-limiting example, an industrial plant for treating metal material, for example a steel plant.

This plant 20 can comprise at least one of either a line 22 for melting metal material or at least one line 23 for rolling the metal material produced by the melting line 22.

The melting line 22 is provided with at least one furnace 24 for melting metal material. The line 23 for rolling metal material is provided with one or more user devices 25, 26, 27 electrically powered by means of the power supply circuit 11 of electrical energy.

The molten metal material produced by the melting line 22 could be transferred to the rolling line 23, for example by means of a continuous casting process.

The user device 25 can be, for example, an induction furnace for heating the metal material along the rolling line 22. The user devices 26 and 27, on the other hand, can be, for example, the means for driving the rollers of the rolling stands for rolling the metal material. Such user devices could also comprise other elements, for example elements associated with the roller ways along which the metal product being rolled flows, and which are normally provided in the rolling line 23, or others.

According to some embodiments, the common bus 12 can be connected to at least one user device 24, for example the electric furnace, by means of at least one direct current connection circuit 31. The direct current connection circuit 31 can be, for example, a so-called DC Link or suchlike, comprising one or more capacitors configured to store direct electrical energy and create a separation with respect to the user device 24 associated therewith.

The common bus 12 can also be connected to one or more user devices 25, 26, 27 by means of at least one direct current connection circuit 32. This direct current connection system 32 can also be, for example, a so-called DC Link or suchlike.

The provision of at least one common bus 12 therefore allows to connect several direct current connection circuits 31, 32 substantially to a single collector, or connection unit 13, which could also be advantageous for compensating load variations, reducing phenomena caused by possible rapid variations in the supply voltage and more.

The direct current flowing in the common bus 12, shared by the different connection circuits 31, 32 and by the different treatment lines 22, 23, is then distributed and possibly suitably reconverted into alternating current upstream of the user devices 24, 25, 26, 27.

In the event that the user devices 24, 25, 26, 27 have to be powered in alternating current AC, respective converter devices can be provided to transform the electrical energy from direct current DC into alternating current AC.

The common bus 12 is substantially defined with a direct voltage nominal value and a certain range of variation with respect to the nominal, linked to the variations of the rectified alternating current network.

This value may not be suitable for all the loads connected to the common bus 12, for example the furnace 24, the user devices 25, 26, 27 or others, therefore in these cases it is necessary to adapt the direct voltage of the different direct current connection systems 31, 32 to the value of the voltage of the common bus 12.

To allow voltage adaptation, at least one high frequency converter 44 can be provided, in particular a DC/DC converter, positioned between the common bus 12 and the storage devices 16, downstream of the connection unit 13.

By high frequency we mean the switching frequency of the switching devices; these converters 44 can be of the step-up/step-down type: the input direct current voltage, supplied by the storage devices 16, is raised or lowered at output of the converter 44 on the basis of the voltage of the common bus 12.

A diagram of the converter 44 to be used could have a buck stage (lowering), a boost stage (raising) and a HF (High Frequency) transformer which guarantees galvanic isolation between input and output.

The same type of conversion can be provided in order to connect the common bus 12 to the different direct current connection circuits 31, 32 connected to the loads present in the plant 20.

Therefore, the present power supply system 10 can comprise one or more high frequency converters 45, suitable to supply galvanic isolation, positioned between the common bus 12 and the direct current connection circuits 31, 32.

According to some embodiments, the power supply circuit 11 comprises a power supply apparatus 21 to power the furnace 24, which can comprise a plurality of power supply modules 33. Each of the power supply modules 33 comprises at least one medium voltage/medium voltage, or medium voltage/low voltage transformer 34, a rectifier 35 connected to the transformer 34 and a converter 36 connected to the rectifier 35.

The rectifiers 34 can comprise devices chosen, for example, from a group comprising Diodes, SCR (Silicon Controlled Rectifier), GTO (Gate Turn-Off Thyristor), IGCT (Integrated Gate-Commutated Thyristor), MCT (Metal-Oxide Semiconductor Controlled Thyristor), BJT (Bipolar Junction Transistor), MOSFET (Metal-Oxide Semiconductor Field-Effect Transistor) and IGBT (Insulated-Gate Bipolar Transistor), SiC (Silicon Carbide Semiconductor), GaN (Gallium Nitride Semiconductor).

The converters 36 can also comprise devices chosen, for example, from a group comprising SCR (Silicon Controlled Rectifier), GTO (Gate Turn-Off Thyristor), IGCT (Integrated Gate-Commutated Thyristor), MCT (Metal-Oxide Semiconductor Controlled Thyristor), BJT (Bipolar Junction Transistor), MOSFET (Metal-Oxide Semiconductor Field-Effect Transistor), and IGBT (Insulated-Gate Bipolar Transistor), SiC (Silicon Carbide Semiconductor), GaN (Gallium Nitride Semiconductor).

The direct current connection system 31 is connected to each of the power supply modules 33 between the rectifier 35 and the converter 36.

A high current circuit 37 is also provided upstream of the melting furnace 12, which can be preceded by disconnecting switches 38 for possible electrical disconnection.

The melting furnace 12 can be an electric arc furnace comprising a plurality of electrodes 39, each of which can be electrically powered by one or more power supply modules 33. The metal material M to be melted can be contained inside a container 40 or shell. The electrodes 39 are configured to strike an electric arc through the metal material M and melt it.

According to some embodiments, the power supply circuit 11 can also comprise a transformer 43 connected between the electricity network 42 and the power supply apparatus 21.

Some embodiments described here also concern a method to power a plant 20, which provides to produce electrical energy from renewable sources in one or more production stations 14 disposed away from the site S where the plant 20 is positioned, and provided with respective energy generating apparatuses 15, to store the electrical energy produced on mobile and transportable storage devices 16, to transfer the storage devices 16 from the production stations 14 to the plant 20 by means of transport means 17 on wheels, and to connect them to a power supply circuit 11 of the plant in order to power one or more user devices 24, 25, 26, 27.

The method can provide to manage and monitor the movements of the transport means 17 and the charge/use of the storage devices 16 as a function of the energy demands of the plant 20 and the availability of electrical energy in the production stations 14.

Furthermore, it can be provided to charge a storage device 16 in a production station 14 until the maximum charge capacity is reached, and subsequently to transfer the storage device 16 to the plant 20 with a respective transport mean 17 and connect it to the power supply circuit 11 by means of the direct current DC connection unit 13, and to power the power supply circuit 11 with the energy supplied by the storage device 16 until the amount of charge present in it falls below a certain threshold level.

The threshold level can be comprised between 2% and 5%, as a function of the total storage capacity of the storage device 16 and of the type of batteries used. According to some embodiments, the threshold level can also be defined as a function of the distance between the site S of the plant 20 and the production station(s) 14, in such a way as to allow the transport mean 17 to reach them using the residual charge part as a source of energy.

Preferably, in correspondence with the connection unit 13 there can be connected, in parallel to each other, two or more storage devices 16, or respective transport means 17, in such a way as to guarantee a continuous power supply of the plant 20.

According to some embodiments, the number of storage devices 16 connected in parallel can be chosen on the basis of one or more of the following parameters:
number of production stations 14 provided;
type of renewable energy sources;
recharging speed of the storage devices 16;
number of storage devices 16 that can be recharged in each production station 14;
distance between the production stations 14 and the site S of the plant 20.

As shown by way of example in FIG. 2, it can be provided that in correspondence with the site S there are various transport means 17 with respective storage devices 16, in the example case six A-F are shown, which have different charge levels C, some of which are in service and are discharging in order to power the user devices, while others are not in service.

For example, the letter A indicates a fully charged C=100% storage device 16 (or battery-truck), which is on stand-by, waiting to be replaced by a discharged storage device 16. The letters from B to D indicate respective storage devices 16 which have a charge C comprised between 100% and the threshold value, and are in service, therefore they are discharging in order to power the power supply circuit 11. The letter E indicates a storage device 16 that has exhausted its useful charge, and has therefore been disconnected in order to be transferred once again to a production station 14. Finally, the letter F indicates a charged storage device 16 that is about to be connected to the power supply circuit 11.

It is clear that modifications and/or additions of parts or steps may be made to the power supply system 10, to the plant 20 and to the method to power a plant 20 as described heretofore, without departing from the field and scope of the present invention as defined by the claims.

In the following claims, the sole purpose of the references in brackets is to facilitate reading: they must not be considered as restrictive factors with regard to the field of protection claimed in the specific claims.

1. Industrial An industrial steel plant for treating materials comprising at least one of either a line for melting metal material provided with at least one furnace, or a rolling line provided with one or more user devices and at least one power supply system for supplying electrical energy comprising a power supply circuit disposed in a site of the plant and configured to feed electrical energy to said user devices, wherein said power supply system comprises:
one or more stations for producing electrical energy from renewable sources which are disposed in different production areas disposed distanced from said site and provided with generating apparatuses configured to receive and transform the energy supplied by the renewable sources into electrical energy;
a plurality of mobile storage devices, configured to store electrical energy and suitable to be transported; and
a plurality of transport means configured to transport said storage devices from said production areas to said site and vice versa, and
a central management unit configured to manage and regulate the movement of said plurality of transport means and of the storage devices associated with them as a function of one or more of either the energy demands of the plant, the availability of electrical energy in the production stations, the distance between said production stations and said plant, the recharging speed and the storage capacity of said storage devices, and to regulate the delivery of the energy received from said storage devices along said power supply circuit as a function of the different treatment process steps in said at least one line.

2. The industrial steel plant as in claim 1, wherein said transport means are transport means on wheels and said storage devices are integrated in the transport means.

3. The industrial steel plant as in claim 1, wherein said power supply circuit comprises at least one common line or bus for direct current connection and at least one connection unit by means of which said common bus is connected to one or more of said electrical energy storage devices in order to receive the electrical energy necessary to power said one or more lines and/or said one or more user devices.

4. The industrial steel plant as in claim 3, wherein said connection unit is provided with two or more connection devices, each suitable to connect with a respective storage device, or with a transport mean associated with a respective storage device, wherein said connection devices are configured to connect said storage devices in parallel to one another.

5. The industrial steel plant as in claim 3, wherein said common bus is connected to said user devices by means of direct current connection circuits and said power supply system comprises one or more high frequency converters, suitable to supply galvanic isolation, positioned between said common bus and said connection circuits.

6. The industrial plant as in claim 3, wherein said power supply circuit comprises a power supply apparatus for said furnace comprising a plurality of power supply modules each having at least a transformer, a rectifier and a converter, connected in parallel to each other to said common bus.

7. The industrial plant as in claim 1, wherein said power supply system comprises at least one alternative energy source connected to said power supply circuit and able to supply power supply energy to the one or more lines for treating materials and/or to the one or more user devices in addition, or as an alternative, to the electrical energy supplied by said storage devices.

8. The industrial plant as in claim 7, wherein the plant is of the hybrid type and comprises a connection to an electricity network and said management unit is configured to manage the supply of electrical energy in said power supply circuit also as a function of the electrical energy supplied by said alternative energy source and said electricity network.

9. A method to power an industrial steel plant for treating materials comprising at least one line for melting metal material provided with at least one furnace and at least one rolling line provided with one or more user devices, further comprising
producing electrical energy from renewable sources in one or more production stations disposed away from a site where said plant is positioned, and provided with respective apparatuses for generating energy;
storing the electrical energy on mobile and transportable storage devices;
transferring said storage devices by transport means on wheels from said production stations to said site and connecting them to a power supply circuit of the plant in order to power said one or more user devices, and
managing and regulating the movement of said plurality of transport means and of said storage devices associated therewith by means of a central management unit as a function of one or more of either the energy demands of the plant, the availability of electrical energy in the production stations, the distance between said production stations and said plant, the recharging speed and the storage capacity of said storage devices, and regulating the delivery of the energy received from said storage devices along said power supply circuit as a function of the different treatment process steps in said at least one line.

10. The method as in claim 9, further providing power to said power supply circuit with the energy supplied by at least one storage device until the amount of charge present therein drops below a determinate threshold level.

11. The method as in claim 9, further including simultaneously connecting at least two of said storage devices to a common line or bus for direct current connection of said power supply circuit and to replace on each occasion one of said storage devices, keeping the other connected, so as to guarantee a continuous power supply of said plant.

12. The method as in claim 9, further including monitoring the state of charge of each storage device associated with a respective transport mean by means of a control unit provided on said transport mean and communicate the data detected to said central management unit.

13. The method as in claim 9, further including powering said plant partly by means of the electrical energy supplied by said storage devices and partly by means of the electrical energy supplied by an alternative energy source connected to said power supply circuit.

14. The method as in claim 9, further including powering said plant partly by means of the electrical energy supplied by said storage devices and partly by means of the electrical energy supplied by an electricity network connected to said power supply circuit.

15. The method as in claim 14, further including introducing into said electricity network the possible residual energy of said storage devices when a scheduled or sudden stoppage of said plant occurs.
